(19) United States
(12) Patent Application Publication
(10) Pub. No.: US 2026/0336455 A1
(43) Pub. Date: Oct. 29, 2026

(54) SYSTEMS AND METHODS FOR CONTROLLING POWER DRAWN FROM A DARK START BATTERY

(71) Applicant: TOYOTA MOTOR NORTH AMERICA, INC., PLANO, TX (US)

(72) Inventor: CHRISTOPHER FERONE, Ann Arbor, MI (US)

(73) Assignees: TOYOTA MOTOR NORTH AMERICA, INC., PLANO, TX (US); TOYOTA JIDOSHA KABUSHIKI KAISHA, Toyota-shi (JP)

(21) Appl. No.: 19/188,584

(22) Filed: Apr. 24, 2025

(51) Int. Cl. B60L 53/63; B60L 53/53; B60L 53/66; B60L 55/00

(52) U.S. Cl. CPC B60L 53/63; B60L 53/53; B60L 53/66; B60L 55/00; B60L 2260/50

(57) ABSTRACT

Systems and methods are provided for controlling an amount of electrical power drawn from a dark start battery of a bidirectional charging system. A method may include detecting a failure of a power grid, the power grid being electrically connected to the bidirectional charging system; and responsive to the detection of the failure of the power grid, controlling the bidirectional charging system to enter a sleep mode for a time interval that is less than or equal to a difference between a current time and an estimated arrival time of a vehicle at a location of the bidirectional charging system, the sleep mode comprising a reduction or a limit on an amount of electrical power the bidirectional charging system draws from the dark start battery.

### TECHNICAL FIELD

The present disclosure relates generally to systems and methods for controlling a bidirectional charging system, and in particular, some implementations may relate to controlling an amount of electrical power drawn from a dark start battery.

### DESCRIPTION OF RELATED ART

A bidirectional vehicle charger may enable a user to charge a vehicle (e.g., a battery electric vehicle (BEV) or a plug-in hybrid electric vehicle (PHEV)) at the user's home using electrical energy supplied from a power grid. In addition, the user may utilize the vehicle as a backup energy source by using the bidirectional vehicle charger to transfer electrical energy from the vehicle to the user's home. This may be especially helpful when the power grid fails such as during a blackout.

### BRIEF SUMMARY OF THE DISCLOSURE

According to various aspects of the disclosed technology, a bidirectional charging system may include a dark start battery. The bidirectional charging system may further include one or more processors and memory coupled to the one or more processors to store instructions, which when executed by the one or more processors, cause the one or more processors to perform operations, the operations comprising: detecting a failure of a power grid, the power grid being electrically connected to the bidirectional charging system; and responsive to the detection of the failure of the power grid, controlling the bidirectional charging system to enter a sleep mode for a time interval that is less than or equal to a difference between a current time and an estimated arrival time of a vehicle at a location of the bidirectional charging system, the sleep mode comprising a reduction or a limit on an amount of electrical power the bidirectional charging system draws from the dark start battery.

According to another aspect of the disclosed technology, a bidirectional charging system may include a dark start battery. The bidirectional charging system may further include one or more processors and memory coupled to the one or more processors to store instructions, which when executed by the one or more processors, cause the one or more processors to perform operations, the operations comprising: estimating an arrival time of a vehicle at a location of the bidirectional charging system, the bidirectional charging system having: (i) a ready mode comprising the bidirectional charging system drawing electrical energy from the dark start battery for initiating a transfer of electrical energy from the vehicle to the bidirectional charging system, and (ii) a sleep mode comprising a reduction or a limit on an amount of electrical power the bidirectional charging system draws from the dark start battery; and controlling the bidirectional charging system to enter either the ready mode or the sleep mode based on a current time and the estimated arrival time of the vehicle.

According to a further aspect of the disclosed technology, a method for controlling a bidirectional charging system may include estimating, via one or more processors of the bidirectional charging system, an arrival time of a vehicle at a location of the bidirectional charging system, the bidirectional charging system having: (i) a ready mode comprising the bidirectional charging system drawing electrical energy from a dark start battery of the bidirectional charging system for initiating a transfer of electrical energy from the vehicle to the bidirectional charging system, and (ii) a sleep mode comprising a reduction or a limit on an amount of electrical power the bidirectional charging system draws from the dark start battery; and controlling, via the one or more processors, the bidirectional charging system to enter either the ready mode or the sleep mode based on a current time and the estimated arrival time of the vehicle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example vehicle with which embodiments of the systems and methods disclosed herein may be implemented.

FIG. 2 illustrates an example architecture for a vehicle bidirectional charging system in accordance with an aspect of the systems and methods described herein.

FIG. 3 is a schematic diagram of an example operating environment for controlling an amount of power drawn from a dark start battery in accordance with an aspect of the systems and methods described herein.

FIG. 4 illustrates an example architecture for a controller of a bidirectional charging system in accordance with an aspect of the systems and methods described herein.

FIG. 5 illustrates an example process for controlling a bidirectional charging system, in accordance with an aspect of the present disclosure.

FIG. 6 illustrates an example process for controlling a bidirectional charging system, in accordance with an aspect of the present disclosure.

FIG. 7 is an example computing component that may be used to implement various features of embodiments described in the present disclosure.

The figures are not exhaustive and do not limit the present disclosure to the precise form disclosed.

### DETAILED DESCRIPTION

As alluded to above, a bidirectional charger may be installed within a user's home and electrically connected to a power grid (e.g., a municipal power grid). This may enable the user to charge a vehicle using electrical energy supplied from the power grid, and to utilize the vehicle as a backup source of electrical energy by transferring electrical energy from the vehicle to the user's home. For example, if the power grid experiences a failure and stops supplying electrical energy to the user's home, the user may connect the vehicle to the bidirectional charger such that the vehicle becomes the source of electrical energy for the home.

To initiate the transfer of electrical energy from the vehicle to the user's home, the bidirectional charger requires electrical energy. For example, the bidirectional charger may require electrical energy to complete a handshake with the vehicle to initiate the transfer of electrical energy from the vehicle. Since the user is likely to utilize the vehicle as a backup power source during a power grid failure, the bidirectional charger cannot rely on the power grid as the source of electrical energy to initiate the transfer of electrical energy from the vehicle. To overcome this problem, the bidirectional charger may rely on a dark start battery as the source of electrical energy. The dark start battery may be charged using electrical energy from the power grid when the power grid is operational, and if a power grid failure occurs, the charged dark start battery may supply electrical energy to the bidirectional charger. For example, when the power grid fails, the bidirectional charger may automatically start drawing electrical energy from the dark start battery to enable the bidirectional charger to be ready to initiate the transfer of electrical energy from the vehicle if the vehicle is connected to the bidirectional charger.

Accordingly, the bidirectional charger may only be able to initiate the transfer of electrical energy from the vehicle for a limited amount of time. As an example, if a blackout occurs on day one (1) and the vehicle isn't connected to the bidirectional charger until day three (3), the dark start battery may not have a sufficient state of charge (SOC) remaining to initiate the transfer of electrical energy from the vehicle.

In appreciation of the above problem and others, aspects of the systems and methods disclosed herein provide for controlling an amount of electrical power drawn from a dark start battery. For example, an aspect may include controlling the amount of electrical power drawn from the dark start battery based on an estimated arrival time of a vehicle at a location of a bidirectional charging system. To control the amount of electrical power drawn from the dark start battery, the bidirectional charging system may be controlled to enter a ready/monitoring mode or a sleep/hibernation mode. In the ready/monitoring mode, the bidirectional charging system may be ready to initiate the transfer of electrical energy from the vehicle to the bidirectional charging system. In the sleep/hibernation mode, the amount of electrical power drawn from the dark start battery may be reduced or limited, for example, by isolating the dark start battery from one or more components of the bidirectional charging system (e.g., by utilizing one or more relays) and/or by otherwise stopping or preventing the supply of electrical energy from the dark start battery to the bidirectional charging system for initiating the transfer of electrical energy from the vehicle.

The bidirectional charging system may estimate the arrival time of the vehicle based on, for example, a location of the vehicle, a heading of the vehicle, historical charging data of the vehicle, or learned behavior of the user/vehicle. As an example, if the bidirectional charging system estimates the vehicle will arrive at the location of the bidirectional charging system in five (5) hours, the bidirectional charging system may enter sleep mode for five (5) (or less) hours. In examples, the bidirectional charging system may periodically check the location of the vehicle to update the estimated arrival time of the vehicle.

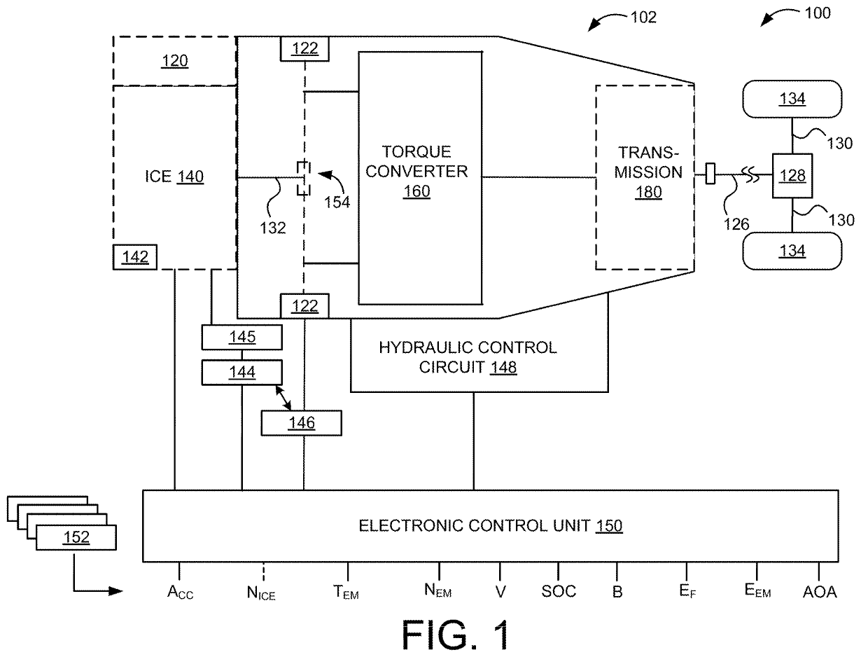

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for controlling an amount of electrical power drawn from a dark start battery can be implemented in other types of vehicle having an electrical port including electric vehicles, gasoline-or diesel-powered vehicles, fuel-cell vehicles, or other vehicles.

FIG. 1 illustrates a drive system 102 of a vehicle 100 that may include an internal combustion engine (ICE) 140 and one or more electric motor(s) 122 (which may also serve as generators, in examples) as sources of motive power. Driving force generated by the ICE 140 and the electric motor(s) 122 can be transmitted to one or more wheel(s) 134 via a torque converter 160, a transmission 180, a differential gear device 128, and a pair of axles 130. In examples, the vehicle 100 may not include one or more of the ICE 140 (e.g., such as in BEV applications), the torque converter 160 (e.g., such as in multi-plate clutch applications), the transmission 180 (e.g., such as in direct drive applications), or the differential gear device 128.

When implemented as an HEV, the vehicle 100 may be driven/powered with either or both of the ICE 140 and the electric motor(s) 122 as the drive source for travel. For example, a first travel mode may be an engine-only travel mode that only uses the ICE 140 as the source of motive power. A second travel mode may be an EV travel mode that only uses the electric motor(s) 122 as the source of motive power. A third travel mode may be an HEV travel mode that uses the ICE 140 and the electric motor(s) 122 as the sources of motive power. In the engine-only and HEV travel modes, the vehicle 100 may rely on the motive force generated at least by the ICE 140, and a clutch 154 may be included to engage the ICE 140. In the EV travel mode, the vehicle 100 may be powered by the motive force generated by the electric motor(s) 122 while the ICE 140 may be stopped (or idling, or operating as a generator, etc.) and the clutch 154 disengaged.

The ICE 140 may be an internal combustion engine such as a gasoline, diesel, biofuel, or similarly powered engine in which fuel is injected into and combusted in one or more combustion chamber(s). A cooling system 120 may be provided to cool the ICE 140 such as, for example, by removing excess heat from the ICE 140. For example, the cooling system 120 may be implemented to include a radiator, a water pump and a series of cooling channels. In operation, the water pump circulates coolant through the ICE 140 to absorb excess heat from the ICE 140. The heated coolant is circulated through the radiator to remove heat from the coolant, and the cold coolant can then be recirculated through the ICE 140. A fan may also be included to increase the cooling capacity of the radiator. The cooling system 120 (e.g., the water pump, the fan, etc.) may operate via a direct or indirect coupling to an output of the ICE 140 (e.g., a crankshaft 132, a driveshaft 126, etc.). In other applications, the cooling system 120 (e.g., either or both the water pump and the fan) may be operated by the electric motor(s) 122 or by electrical energy such as from a battery 144.

In examples, the drive system 102 may include an output control circuit 142 to control drive (e.g., output torque) of the ICE 140. The output control circuit 142 may include a throttle actuator to control an electronic throttle valve that controls fuel injection, an ignition device that controls ignition timing, and the like. The output control circuit 142 may execute output control of the ICE 140 according to one or more command control signal(s) supplied from an electronic control unit (ECU) 150, described below. Such output control may include, for example, throttle control, fuel injection control, and ignition timing control.

The clutch 154 may be included to engage and disengage the ICE 140 from other portions of the drivetrain of the vehicle 100. In the example illustrated in FIG. 1, the crankshaft 132, which is an output member of the ICE 140, may be selectively coupled to either or both of the electric motor(s) 122 and the torque converter 160 via the clutch 154. The clutch 154 may be implemented as, for example, a multiple disc type hydraulic frictional engagement device whose engagement is controlled by an actuator such as a hydraulic actuator. The clutch 154 may be controlled such that its engagement state is complete engagement, slip engagement, and complete disengagement, depending on the pressure applied to the clutch 154. For example, a torque capacity of the clutch 154 may be controlled according to the hydraulic pressure supplied from a hydraulic control circuit 148. When the clutch 154 is engaged, power transmission is provided in the power transmission path between the crankshaft 132 and the torque converter 160. On the other hand, when the clutch 154 is disengaged, motive power from the ICE 140 is not delivered to the torque converter 160. In a slip engagement state, the clutch 154 is engaged, and motive power is provided to the torque converter 160 according to a torque capacity (transmission torque) of the clutch 154.

The torque converter 160 may be included to control the application of power from the ICE 140 and the electric motor(s) 122 to the transmission 180. The torque converter 160 may include a viscous fluid coupling that transfers rotational power from the motive power source to the driveshaft 126 via the transmission 180. The torque converter 160 may include a conventional torque converter or a lockup torque converter. In examples, a mechanical clutch or a multi-plate clutch may be used in place of the torque converter 160.

The electric motor(s) 122 may be used to provide motive power for the vehicle 100 and may be powered electrically via the battery 144. The electric motor(s) 122 may be powered by the battery 144 to generate a motive force to move the vehicle 100 and adjust vehicle speed, for example. The electric motor(s) 122 may also function as a generator to generate electrical power such as, for example, when coasting or braking. The electric motor(s) 122 may be electrically connected to the battery 144 via an inverter 146.

The battery 144 may be implemented as one or more batteries or other power storage devices including, for example, lead-acid batteries, nickel-metal hydride batteries, lithium ion batteries, lithium ion polymer batteries, capacitive storage devices, nickel cadmium batteries, or other types of batteries. The battery 144 may be charged by a battery charger 145 that receives energy from the ICE 140. For example, an alternator or generator may be coupled directly or indirectly to an output of the ICE 140 (e.g., the crankshaft 132, the driveshaft 126, etc.) to generate an electrical current as a result of the operation of the ICE 140. In examples, a clutch may be included to engage/disengage the battery charger 145. As alluded to above, the battery 144 may also be charged by the electric motor(s) 122 such as, for example, by regenerative braking or by coasting during which time the electric motor(s) 122 operate as generator(s). In addition or alternatively, in examples, the battery 144 may be charged via an external AC or DC power source (e.g., such as in BEV applications or plug-in hybrid electric vehicle (PHEV) applications). The battery 144 may also be used to power other electrical or electronic systems in the vehicle 100.

As alluded to above, the vehicle 100 may further include the ECU 150. The ECU 150 may control the electric drive components of the vehicle as well as other vehicle components and systems. For example, the ECU 150 may control the inverter 146, adjust driving current supplied to the electric motor(s) 122, and adjust the current received from the electric motor(s) 122 during regenerative coasting and braking. As a more particular example, output torque of the electric motor(s) 122 can be increased or decreased by the ECU 150 through the inverter 146.

The ECU 150 may include circuitry to control various aspects of the vehicle 100's operation. The ECU 150 may include, for example, a microcomputer that includes one or more processing units (e.g., microprocessors), memory storage (e.g., RAM, ROM, etc.), and I/O devices. The processing units of the ECU 150 may execute instructions stored in memory to control one or more electrical systems or subsystems in the vehicle 100. The ECU 150 may include a plurality of electronic control units such as, for example, an electronic engine control module, a powertrain control module, a transmission control module, a suspension control module, a body control module, and so on. As a further example, electronic control units may be included to control systems and functions such as doors and door locking, lighting, human-machine interfaces, cruise control, telematics, braking systems (e.g., ABS or ESC), battery management systems, and so on. These various control units may be implemented using two or more separate electronic control units, or using a single electronic control unit.

In the example illustrated in FIG. 1, the ECU 150 receives information from a plurality of sensors included in the vehicle 100. For example, the ECU 150 may receive signals that indicate vehicle operating conditions or characteristics, or signals that can be used to derive vehicle operating conditions or characteristics. These may include, but are not limited to: accelerator operation amount, AOC; a revolution speed of the ICE 140, N_{ICE} (engine RPM); a rotational speed of the electric motor(s) 122, N_{EM} (electric motor rotational speed); and vehicle speed, V. These may also include electric motor output, T_{EM} (e.g., output torque), brake operation amount/pressure, B; and battery SOC (i.e., the charged amount for the battery 144 detected by an SOC sensor). Accordingly, the vehicle 100 may include a plurality of sensors 152 that can be used to detect various conditions internal or external to the vehicle 100 and provide sensed conditions to the ECU 150 (which, again, may be implemented as one or a plurality of individual control circuits). In examples, the sensors 152 may be included to detect one or more conditions directly or indirectly such as, for example: fuel efficiency, E_{F}; electric motor(s) 122 efficiency, E_{EM}; hybrid (ICE 140+electric motors(s) 122) efficiency; acceleration, A_{CC}; etc.

In examples, one or more of the sensors 152 may include their own processing capability to compute the results for additional information that can be provided to the ECU 150. In addition or alternatively, in examples, one or more of the sensors 152 may be data-gathering-only sensors that provide only raw data to the ECU 150. In further examples, in addition or alternatively, hybrid sensors may be included that provide a combination of raw data and processed data to the ECU 150. The sensors 152 may provide an analog output or a digital output, or a combination thereof.

The sensors 152 may be included to detect not only vehicle conditions but also to detect external conditions as well. Sensors that might be used to detect external conditions can include, for example, sonar (e.g., ultrasonic), radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which aspects of the disclosed technology may be implemented. One of ordinary skill in the art reading this description will understand how the disclosed examples can be implemented with this and other vehicle platforms (e.g., BEVs, fuel-cell vehicles, ICE vehicles, etc.).

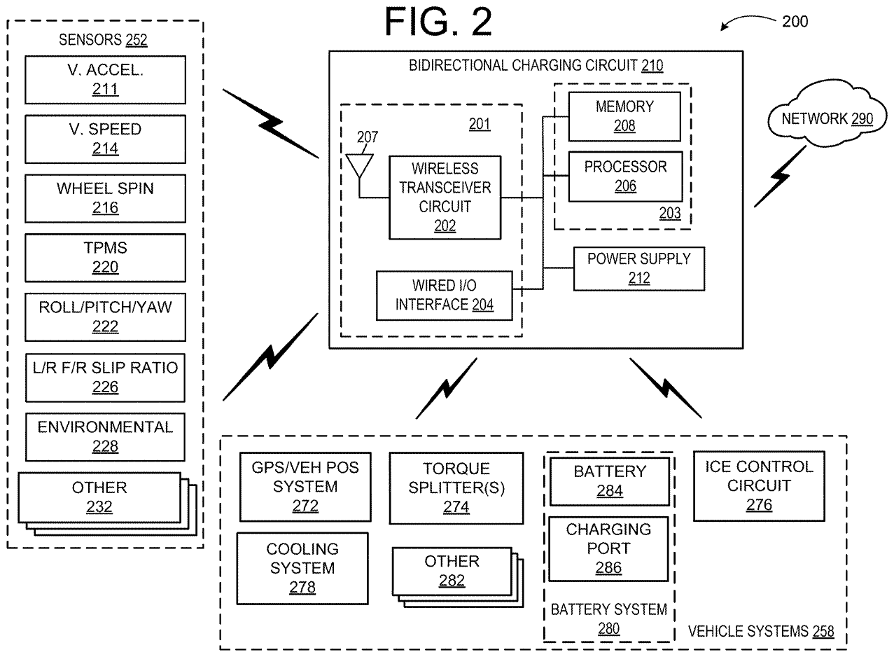

FIG. 2 illustrates an example architecture for a vehicle bidirectional charging system 200 in accordance with an aspect of the systems and methods described herein. Referring now to FIG. 2, in this example, the vehicle bidirectional charging system 200 includes a bidirectional charging circuit 210, a plurality of sensors 252, and a plurality of vehicle systems 258. The sensors 252 and vehicle systems 258 may communicate with the bidirectional charging circuit 210 via either or both of a wired or wireless communication interface. Although the sensors 252 and vehicle systems 258 are depicted as communicating with the bidirectional charging circuit 210, they can also communicate with each other as well as with other vehicle systems. The bidirectional charging circuit 210 may be implemented as an electronic control unit (ECU) or as part of an ECU such as, for example the ECU 150. In examples, the bidirectional charging circuit 210 may be implemented independently of the ECU 150.

The bidirectional charging circuit 210 in this example includes a communication circuit 201, a decision circuit 203 (including a processor 206 and memory 208 in this example) and a power supply 212. Components of the bidirectional charging circuit 210 are illustrated as communicating with each other via a data bus, although other communication interfaces can be included.

The processor 206 may include one or more GPUs, CPUs, microprocessors, or any other suitable processing system. The processor 206 may include a single core or multicore processor. The memory 208 may include one or more various forms of memory or data storage (e.g., flash, RAM, etc.) that may be used to store the calibration parameters, images (analysis or historic), point parameters, instructions and variables for the processor 206 as well as any other suitable information. The memory 208 may be made up of one or more modules of one or more different types of memory and may be configured to store data and other information as well as operational instructions that may be used by the processor 206 to operate the bidirectional charging circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up the bidirectional charging circuit 210.

The communication circuit 201 may utilize either or both of a wireless transceiver circuit 202 with an associated antenna 207 and a wired I/O interface 204 with an associated hardwired data port. As this example illustrates, communications with the bidirectional charging circuit 210 can include either or both wired and wireless communications. The wireless transceiver circuit 202 can include a transmitter and a receiver to allow wireless communications via any of a number of communication protocols such as, for example, WiFi, Bluetooth, near field communications (NFC), Zigbee, or any of a number of other wireless communication protocols whether standardized, proprietary, open, point-to-point, networked or otherwise. The antenna 207 may be coupled to the wireless transceiver circuit 202 and may be used by the wireless transceiver circuit 202 to transmit signals (e.g., radio frequency (RF) signals) wirelessly to wireless equipment with which it is connected and to receive radio signals as well (e.g., via a network 290 such as a cellular network (e.g., CDMA, 3G, 4G, 5G, etc.), a satellite network, etc.). These signals can include information of almost any sort that is sent or received by the bidirectional charging circuit 210 to/from other entities such as a server or other computing device (e.g., a phone, a tablet, etc.).

The wired I/O interface 204 may include a transmitter and a receiver for hardwired communications with other devices. For example, the wired I/O interface 204 may provide a hardwired interface to other components, including the sensors 252 and the vehicle systems 258. The wired I/O interface 204 may communicate with other devices using Ethernet or any of a number of other wired communication protocols whether standardized, proprietary, open, point-to-point, networked or otherwise.

The power supply 212 can include one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, etc.), an energy harvester (e.g., solar cells, piezoelectric system, etc.), or any other suitable power supply.

The sensors 252 may be or include, for example, one or more of the sensors 152 described above with reference to the example of FIG. 1. The sensors 252 may include additional sensors that may or may not otherwise be included on a standard vehicle with which the bidirectional charging circuit 210 is implemented. In the illustrated example, the sensors 252 include vehicle acceleration sensors 211, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, left-right and front-rear slip ratio sensors 226, and environmental sensors 228 (e.g., to detect temperature, humidity, salinity, or other environmental conditions). Additional or other sensors 232 may also be included (or one or more of the sensors 252 may be excluded) as may be appropriate for a given implementation of the vehicle bidirectional charging system 200.

The vehicle systems 258 may include any of a number of different vehicle components or subsystems used to control or monitor various aspects of a vehicle (e.g., the vehicle 100) and its performance. In this example, the vehicle systems 258 include a global positing system (GPS) or other vehicle positioning system 272; torque splitters 274 that can control distribution of power among the vehicle wheels such as, for example, by controlling front/rear and left/right torque split; ICE control circuit 276 to control the operation of an engine (e.g. ICE 140); cooling system 278 (e.g., cooling system 120) to provide cooling for the motors, power electronics, the battery, the engine, or other vehicle systems; and a battery system 280. Additional or other vehicle systems 282 may also be included (or one or more of the vehicle systems 258 may be excluded) as may be appropriate for a given implementation of the vehicle bidirectional charging system 200.

The vehicle positioning system 272 may comprise a global navigation satellite system (GNSS) sensor, a GPS sensor, or other types of vehicle positioning sensors. The vehicle positioning system 272 may be configured to generate location information or data for a vehicle (e.g., the vehicle 100) and/or location data for landmarks in the environment surrounding of the vehicle (e.g., intersections or corners of a road). This vehicle location information or data may comprise approximate coordinates (e.g., latitude, longitude, and altitude) of the vehicle's position on the Earth's surface. In examples, the vehicle location information or data may further comprise speed and/or direction/heading information of the vehicle.

The battery system 280 may comprise one or more batteries 284 (e.g., the battery 144) and a charging port 286. In examples, the battery system 280 may include additional components such as a battery management system (BMS). The battery system 280 may provide electrical energy to a vehicle (e.g., the vehicle 100) for propulsion and for powering other vehicle systems. In examples, the one or more batteries 284 of the battery system 280 may be charged by connecting an AC source to the charging port 286. Optionally or alternatively, in examples, a DC source may be used to charge the one or more batteries 284. The one or more batteries 284 may be charged using any of a level 1, level 2, level 3, or other charging standard. The charging port 286 may be a standardized or a proprietary charging port. For example, the charging port 286 may be based on SAE J1772, CCS Type 1/Type 2, or other charging port styles/standards. The battery system 280 may include either or both of an AC/DC converter (e.g., to convert received AC to DC to charge the one or more batteries 284) or a DC/AC inverter (e.g., to convert DC from the one or more batteries 284 to AC for powering one or more electrical motors (e.g., the electrical motor(s) 122)).

With continued reference to FIG. 2, the bidirectional charging circuit 210 may be integrated with one or more components of the battery system 280 or may be separate from the battery system 280. The bidirectional charging circuit 210 may control charging of the one or more batteries 284 by external AC or DC sources. In addition or alternatively, the bidirectional charging circuit 210 may control the transfer of electrical energy from the one or more batteries 284 to one or more loads that are connected to the charging port 286. For example, the bidirectional charging circuit 210 may control the battery system 280 to provide electrical power to a power grid (e.g., vehicle-to-grid (V2G)), a home (e.g., vehicle-to-home (V2H)), a building (e.g., vehicle-to-building (V2B)), or other loads (e.g., vehicle-to-load (V2L)). The bidirectional charging circuit 210 may initiate the transfer of electrical energy from the one or more batteries 284 to the load(s) that are connected to the charging port 286 upon communication with the load(s) (e.g., an electronic handshake). For example, the bidirectional charging circuit 210 may utilize ISO 15118 or other standards to interface with the load(s). In examples, the bidirectional charging circuit 210 may be or include an electric vehicle communication controller (EVCC) and the load(s) (or a component electrically connected to the load(s)) may include a supply equipment communication controller (SECC).

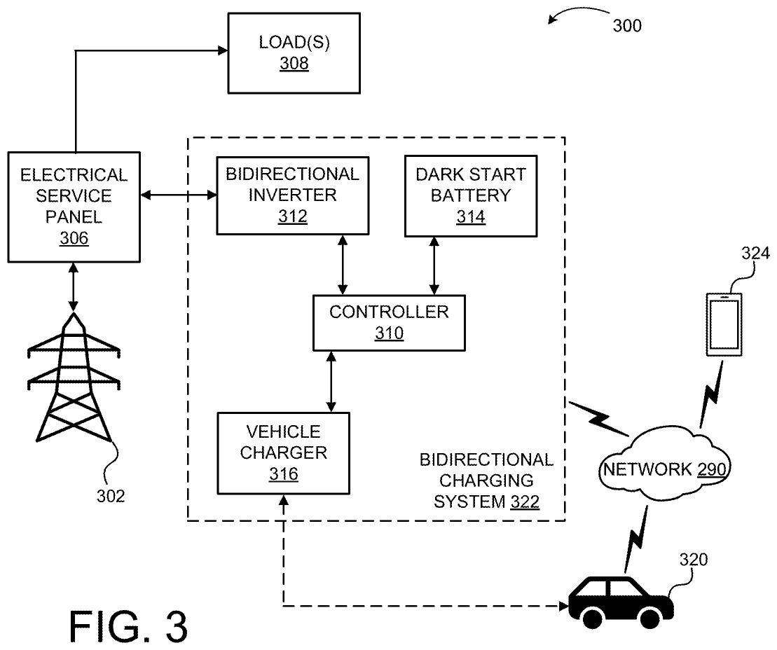

FIG. 3 is a schematic diagram of an example operating environment 300 for controlling a dark start battery 314 in accordance with an aspect of the systems and methods described herein. The operating environment 300, in this example, includes an electrical power grid 302, an electrical service panel 306, a bidirectional charging system 322, and a vehicle 320. The power grid 302 may be a municipal power grid, for example. The power grid 302, for example, may supply 110 volts, 220 volts, or some other voltage. The power grid 302 may be electrically connected to an electrical system of a home or other building or structure. For example, the power grid 302 may be electrically connected to the electrical service panel 306 of a user's home. Although various examples herein refer to a user's home, as alluded to above, the bidirectional charging system 322 or other components of the operating environment 300 may be implemented in other types of buildings or structures such as a parking garage, an office building, a retail building, etc.

Either or both of the electrical service panel 306 and the bidirectional charging system 322 may be integrated with an electrical system of the user's home. For example, the user's home may receive electrical energy (e.g., 110 volts, 220 volts, 240 volts etc.) from the power grid 302 (e.g., which may be supplied by a municipal power utility) via the electrical service panel 306. The electrical service panel 306 may distribute the electrical energy to one or more load(s) 308 that are electrically connected to the service panel 306 (e.g., via wiring, one or more subpanel(s), one or more outlet(s), etc. of the home's electrical system). The load(s) 308 may include, but are not limited to, appliances, lights, air conditioning units, and other electronic devices.

The bidirectional charging system 322 may be electrically connected to the electrical service panel 306 to receive electrical energy from the power grid 302. In this example, the bidirectional charging system 322 includes a bidirectional inverter 312, a vehicle charger 316, a controller 310, and a dark start battery 314 (that also may be referred to as a black start battery). The bidirectional charging system 322 may provide electrical energy to and receive electrical energy from the vehicle 320. For example, the bidirectional inverter 312 may be electrically connected to the electrical service panel 306 and may receive electrical energy (e.g., AC) from the power grid 302 via the electrical service panel 306. The bidirectional inverter 312 may convert the received AC to DC. The vehicle charger 316 may be electrically connected to the bidirectional inverter 312 and may receive the DC from the bidirectional inverter 312. The vehicle charger 316 may supply the received DC to the vehicle 320 when the vehicle 320 is electrically connected to the vehicle charger 316. In examples, the vehicle charger 316 may supply AC (e.g., that the vehicle charger 316 receives from the electrical service panel 306 or the bidirectional inverter 312) to the vehicle 320. The vehicle charger 316 may include one or more cables having one or more electrical plugs for electrically connecting to the vehicle 320. The one or more electrical plugs of the vehicle charger 316 may be complementary to the charging port 286 (marked in FIG. 2).

The vehicle 320 may correspond to the vehicle 100 of FIG. 1 or another BEV, PHEV, etc. The vehicle 320 may include some or all of the components of the vehicle bidirectional charging system 200 of FIG. 2. For example, the vehicle 320 may include the bidirectional charging circuit 210, the battery system 280, and the vehicle positioning system 272. The vehicle 320 may be electrically connected to the vehicle charger 316 by plugging a cable of the vehicle charger 316 into the charging port 286 (marked in FIG. 2) of the vehicle 320. Upon being electrically connected to the vehicle charger 316, the vehicle 320 may receive electrical energy to charge the one or more batteries 284 (marked in FIG. 2) of the vehicle 320. In examples, the vehicle 320 may supply DC to the bidirectional charging system 322. In addition or alternatively, in examples, the vehicle 320 may supply AC to the bidirectional charging system 322. When the vehicle 320 supplies DC to the bidirectional charging system 322, the bidirectional inverter 312 may receive the DC via the vehicle charger 316. The bidirectional inverter 312 may convert the DC to AC and provide the AC to the electrical service panel 306 (e.g., to power the load(s) 308) and/or the power grid 302.

The controller 310 of the bidirectional charging system 322 may control the supply and receipt of electrical energy or power to and from the vehicle 320. For example, the controller 310 may communicate with the bidirectional charging circuit 210 (marked in FIG. 2) of the vehicle 320 when the vehicle 320 is electrically connected to the vehicle charger 316 (e.g., via an electronic handshake). The controller 310 may utilize ISO 15118 or other standards to interface with the bidirectional charging circuit 210, for example. The controller 310 may transmit one or more initiation signals to the bidirectional charging circuit 210 to initiate the transfer of electrical energy from the one or more batteries 284 (marked in FIG. 2) of the vehicle 320 to the load(s) 308 via the vehicle charger 316, the bidirectional inverter 312, and the electrical service panel 306. The controller 310 may also initiate the delivery of electrical energy to the one or more batteries 284 of the vehicle 320 from the power grid 302 via the electrical service panel 306, the bidirectional inverter 312, and the vehicle charger 316.

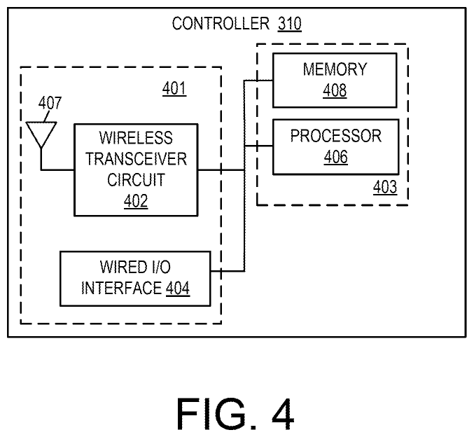

In examples, the controller 310 may be integrated with the dark start battery 314. In addition or alternatively, in examples, the controller 310 may be integrated with the vehicle charger 316 and/or the bidirectional inverter 312. The controller 310 may communicate with one or more of the electrical service panel 306, the bidirectional inverter 312, the dark start battery 314, or the vehicle charger 316 using either or both of a wired or wireless connection. Referring briefly to FIG. 4, the controller 310 may include a communication circuit 401 and a decision circuit 403 (including a processor 406 and memory 408 in this example). In examples, the controller 310 may comprise a bidirectional charging circuit or an SECC. Components of the controller 310 are illustrated as communicating with each other via a data bus, although other communication interfaces can be included.

The processor 406 may include one or more GPUs, CPUs, microprocessors, or any other suitable processing system. The processor 406 may include a single core or multicore processor. The memory 408 may include one or more various forms of memory or data storage (e.g., flash, RAM, etc.) that may be used to store the calibration parameters, point parameters, instructions and variables for the processor 406 as well as any other suitable information (e.g., charging data of the vehicle 320 indicating when the vehicle 320 is plugged into and out of the vehicle charger 316). The memory 408 may be made up of one or more modules of one or more different types of memory and may be configured to store data and other information as well as operational instructions that may be used by the processor 406 to operate the controller 310.

Although the example of FIG. 4 is illustrated using processor and memory circuitry, as described below with reference to circuits disclosed herein, the decision circuit 403 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up the controller 310.

The communication circuit 401 may utilize either or both of a wireless transceiver circuit 402 with an associated antenna 407 and a wired I/O interface 404 with an associated hardwired data port. As this example illustrates, communications with the controller 310 can include either or both wired and wireless communications. The wireless transceiver circuit 402 can include a transmitter and a receiver to allow wireless communications via any of a number of communication protocols such as, for example, WiFi, Bluetooth, near field communications (NFC), Zigbee, or any of a number of other wireless communication protocols whether standardized, proprietary, open, point-to-point, networked or otherwise. The antenna 407 may be coupled to the wireless transceiver circuit 402 and may be used by the wireless transceiver circuit 402 to transmit signals (e.g., radio frequency (RF) signals) wirelessly to wireless equipment with which it is connected and to receive radio signals as well (e.g., via the network 290). These signals can include information of almost any sort that is sent or received by the controller 310 to/from other entities such as a server, a mobile device, or the vehicle 320.

The wired I/O interface 404 may include a transmitter and a receiver for hardwired communications with other devices. For example, the wired I/O interface 404 may provide a hardwired interface to other components, such as the bidirectional inverter 312, the dark start battery 314, and the vehicle charger 316. The wired I/O interface 404 may communicate with other devices using Ethernet or any of a number of other wired communication protocols whether standardized, proprietary, open, point-to-point, networked or otherwise.

Referring again to FIG. 3, as alluded to above, the user may utilize the vehicle 320 as a backup energy source for the user's home (e.g., to power the load(s) 308) when the power grid 302 fails, such as during a blackout, by receiving electrical power from the vehicle 320. For example, during a blackout, the user may connect the vehicle charger 316 to the vehicle 320 such that electrical energy may be transferred from the one or more batteries 284 through the vehicle charger 316 to the load(s) 308 of the home as described above. In examples, the bidirectional charging system 322 may include a manual or automatic switch that may electrically isolate the user's home from the power grid 302 (e.g., by cutting an electrical connection between the electrical service panel 306 and the power grid 302) to prevent electrical energy leaking into the power grid 302.

During a blackout, the bidirectional charging system 322 may utilize electrical energy from the dark start battery 314 to initiate the transfer of electrical energy from the vehicle 320. The dark start battery 314 may be implemented as one or more batteries or other power storage devices including, for example, lead-acid batteries, nickel-metal hydride batteries, lithium-ion batteries, lithium-ion polymer batteries, capacitive storage devices, nickel cadmium batteries, or other types of batteries. In examples, the dark start battery 314 may be a low voltage battery such as 5 volts, 9 volts, 12 volts, etc. The dark start battery 314 may be charged using electrical energy from the power grid 302 when the power grid 302 is operational and supplying electrical energy to the bidirectional charging system 322.

The dark start battery 314 may provide electrical energy to one or more of the bidirectional inverter 312, the controller 310, and the vehicle charger 316 such that the bidirectional charging system 322 is in a ready/monitoring mode/state (also may be referred to as a first mode/state). When the bidirectional charging system 322 is in the ready mode, the bidirectional charging system 322 may draw electrical energy from the dark start battery 314 for initiating the transfer of electrical energy from the vehicle 320. For example, the bidirectional charging system 322 may draw electrical energy from the dark start battery 314 to transmit the one or more initiation signals (e.g., via the controller 310 and the vehicle charger 316) to the vehicle 320 to initiate the transfer of electrical energy from the vehicle 320. In examples, the bidirectional charging system 322 may continuously or periodically transmit the one or more initiation signals when the bidirectional charging system 322 is in the ready mode.

To preserve the SOC of the dark start battery 314, the bidirectional charging system 322 may control or limit (e.g., via the controller 310) an amount of electrical power drawn from the dark start battery 314 when the vehicle 320 is not located at or near the user's home (and thus is not located at or near the bidirectional charging system 322). To control or limit the amount of electrical power drawn from the dark start battery 314, the bidirectional charging system 322 may be controlled to enter a sleep/hibernation mode/state (also may be referred to as a second mode/state). When the bidirectional charging system 322 is in the sleep mode, the dark start battery 314 may, for example, be isolated (e.g., via one or more relays controlled by the controller 310) from one or more components of the bidirectional charging system 322 (e.g., the bidirectional inverter 312 and/or the vehicle charger 316). In addition or alternatively, in examples, the controller 310 may stop or prevent the bidirectional charging system 322 from drawing electrical energy from the dark start battery 314 for initiating the transfer of electrical energy from the vehicle 320 (e.g., by stopping or preventing the one or more initiation signals from being generated or transmitted).

The sleep mode may conserve the SOC of the dark start battery 314 during periods where the user is unlikely to utilize the bidirectional charging system 322 since the vehicle 320 is not located at or near the user's home. Accordingly, the dark start battery 314 may have a sufficient SOC (e.g., to initiate the transfer of electrical energy from the vehicle 320 to the user's home) for a longer period of time compared to a scenario where the electrical power drawn from the dark start battery 314 is not controlled or limited. This may be helpful, for example, during a prolonged blackout (e.g., seven (7) days) where the user connects the vehicle 320 to the bidirectional charging system 322 after a few days.

In examples, the bidirectional charging system 322 may control or limit the amount of electrical power drawn from the dark start battery 314 based on an estimated arrival time of the vehicle 320 at a location of the bidirectional charging system 322. In examples, the estimated arrival time of the vehicle 320 may be based on a location of the vehicle 320. As an example, the estimated arrival time of the vehicle 320 may be derived from or indicated by a distance between the vehicle 320 and the bidirectional charging system 322 and/or a travel time from the location of the vehicle 320 to the bidirectional charging system 322. For example, when the vehicle 320 is more than a threshold distance (e.g., 10 miles, 25 miles, 50 miles, etc.) and/or a threshold travel time (e.g., 1 hour, 3 hours, 5 hours, etc.) from the home (and thus also from the bidirectional charging system 322), the bidirectional charging system 322 may control or limit the amount of electrical power drawn from the dark start battery 314.

The bidirectional charging system 322 may periodically determine (e.g., via the controller 310) the location of the vehicle 320 to determine whether to continue controlling or limiting the amount of electrical power drawn from the dark start battery 314. In examples, the bidirectional charging system 322 may determine (e.g., via the controller 310) when to check the location of the vehicle 320 again or when to stop limiting the power drawn based on a determined travel time of the vehicle 320. For example, if the bidirectional charging system 322 determines that the vehicle 320 is at least five (5) hours from the home, the bidirectional charging system 322 may not determine the location of the vehicle 320 again for five (5) hours (in examples, the bidirectional charging system 322 may check the vehicle 320's location again after a time interval that is less than the determined travel time of the vehicle 320).

In addition or alternatively, in examples, the bidirectional charging system 322 may control or limit the amount of electrical power drawn from the dark start battery 314 based on the location of the vehicle 320 and a heading of the vehicle 320. For example, when the vehicle 320 is more than a threshold distance and/or a threshold travel time from the home, and the vehicle 320 is traveling away from the home, the bidirectional charging system 322 may control or limit the amount of electrical power drawn from the dark start battery 314. As an example, if the bidirectional charging system 322 determines that the vehicle 320 is at least five (5) hours from the home and the vehicle 320 is traveling away from the home, the bidirectional charging system 322 may control or limit the amount of electrical power drawn from the dark start battery 314 for five (5) hours or more than five (5) hours (e.g., 5.5 hours).

In addition or alternatively, in examples, the bidirectional charging system 322 may control or limit the amount of electrical power drawn from the dark start battery 314 based on either or both of the location of the vehicle 320 and the heading of the vehicle 320, and learned behavior of the user/driver of the vehicle 320. For example, the bidirectional charging system 322 may learn to associate certain locations with an average time the vehicle 320 will be located there, average departure times from the locations, and/or average arrival times at the home when the vehicle 320 visits the locations. As an example, the bidirectional charging system 322 may learn that the vehicle 320 generally departs from a certain office building at 6:00 p.m. and may control or limit the amount of electrical power drawn from the dark start battery 314 accordingly (e.g., by controlling or limiting the amount of electrical power drawn from the dark start battery 314 between a current time (e.g., 1:00 p.m.) and an expected arrival time of the vehicle 320 (e.g., 6:30 p.m.)).

The bidirectional charging system 322 may determine the location and the heading of the vehicle 320 based on location information received from the vehicle 320. For example, the bidirectional charging circuit 210 (marked in FIG. 2) may determine the vehicle 320's location information (e.g., via the vehicle positioning system 272 (marked in FIG. 2)) and may transmit (e.g., via the wireless transceiver circuit 202) the location information to the bidirectional charging system 322 (e.g., via the network 290).

In examples, the bidirectional charging system 322 may control or limit the amount of electrical power drawn from the dark start battery 314 based on a dwell time (or EV dwell time) forecast or estimate (thus not needing the vehicle 320's location information). The dwell time forecast or estimate may be based on historical charging data (also may be referred to as historical dwell time data) of the vehicle. The historical charging data may indicate when the vehicle 320 is charged (or plugged and unplugged from the vehicle charger 316). For example, the bidirectional charging system 322 may learn the average arrival times of the vehicle 320 at the home for specific days of the week based on the historical charging data. As an example, if a blackout occurs at 10:00 a.m. and the vehicle 320 has an estimated arrival time at the home of 7:00 p.m., the bidirectional charging system 322 may control or limit the amount of electrical power drawn from the dark start battery 314 between 10:00 a.m. and 7:00 p.m. (or earlier than 7:00 p.m.).

In addition or alternatively, in examples, the bidirectional charging system 322 may control or limit the amount of electrical power drawn from the dark start battery 314 in response to receiving one or more control signals from a device 324 of the user (e.g., a computer, a laptop, a tablet, a phone, etc.). For example, the user may use the device 324 (e.g., and a software application) to transmit the one or more control signals (e.g., via the network 290) to the bidirectional charging system 322 to manually limit the amount of electrical power drawn from the dark start battery 314 (e.g., by putting the bidirectional charging system 322 into sleep mode). In examples, the bidirectional charging system 322 may transmit a notification to the device 324 in response to the bidirectional charging system 322 detecting a blackout. The notification may provide the user an option to set an estimated arrival time of the user at the user's home or an option to limit the amount of electrical power drawn from the dark start battery 314 indefinitely.

In addition or alternatively, in examples, the bidirectional charging system 322 may control or limit the amount of electrical power drawn from the dark start battery 314 when an input device (e.g., a button, a switch, a dial, a touch sensitive screen or button, etc.) is actuated by the user. In examples, the user may place the bidirectional charging system 322 in the ready mode by actuating the input device. The input device may be electrically connected to the bidirectional charging system 322 (e.g., to the controller 310). The input device may function as a manual override of a current mode of the bidirectional charging system 322.

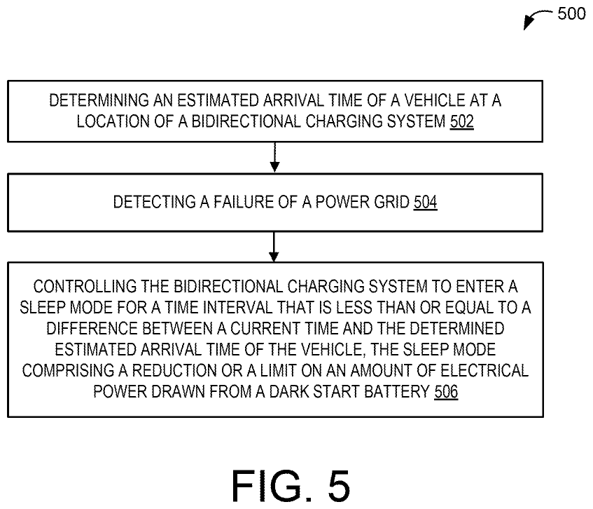

FIG. 5 illustrates an example process 500 for controlling a bidirectional charging system. The process 500 may be implemented as instructions, for example, stored on the controller 310, that when executed by one or more processors perform one or more operations of process 500. The process 500 will be described below with reference to FIG. 3 as an illustrative example. However, one skilled in the art will appreciate that the embodiments disclosed herein are not to be limited to this implementation only.

The process 500 may include determining an estimated arrival time of the vehicle 320 at a location of the bidirectional charging system 322 (502). In examples, the process 500 may further include determining a location of the vehicle 320 based on location information received from the vehicle 320, with determining the estimated arrival time of the vehicle 320 at the location of the bidirectional charging system 322 being based on the determined location of the vehicle 320. In examples, the determined location of the vehicle 320 may be used to determine a travel distance or time between the vehicle 320 and the bidirectional charging system 322. The bidirectional charging system 322 may, for example, determine the estimated arrival time of the vehicle 320 based on the determined travel distance or time (e.g., by utilizing GPS navigation information, traffic data, a lookup table correlating travel distances with average travel times, etc.).

In some examples, estimated arrival time of the vehicle 320 at the location of the bidirectional charging system 322 may be determined based on historical charging data of the vehicle 320. For example, the historical charging data may indicate the average times (e.g., on respective days of a week) the vehicle 320 is plugged into and out of the bidirectional charging system 322.

The process 500 may include detecting a failure of the power grid 302 (504). The failure of the power grid 302 may be a blackout (whether intentional or non-intentional), intermittent or unstable power delivery, or other failures that affect the delivery of electrical energy. In examples, one or more sensors may be used to detect the failure of the power grid 302. The one or more sensors may include current sensors or other sensors for detecting a power grid failure. In examples, the one or more sensors may be in wired or wireless communication with the bidirectional charging system 322 (e.g., with the controller 310). In examples, detecting the failure of the power grid 302 may be subsequent to determining the estimated arrival time of the vehicle 320 at the location of the bidirectional charging system 322. In some examples, the operation of determining the estimated arrival time of the vehicle 320 at the location of the bidirectional charging system 322 may be responsive to detecting the failure of the power grid 302.

The process 500 may include controlling the bidirectional charging system 322 to enter a sleep mode for a time interval that is less than or equal to a difference between a current time and the determined estimated arrival time of the vehicle 320, with the sleep mode comprising a reduction or a limit on an amount of electrical power drawn from the dark start battery 314 (506).

In some examples, the process 500 may further include, upon expiration of the time interval, controlling the bidirectional charging system 322 to enter a ready mode, the ready mode comprising the bidirectional charging system 322 drawing electrical energy from the dark start battery 314 for initiating a transfer of electrical energy from the vehicle 320 to the bidirectional charging system 322. In examples, controlling the bidirectional charging system 322 to enter the sleep mode may comprise stopping or preventing the bidirectional charging system 322 from drawing the electrical energy from the dark start battery 314 for initiating the transfer of electrical energy from the vehicle 320 to the bidirectional charging system 322 thereby reducing or limiting the amount of electrical power drawn from the dark start battery 314.

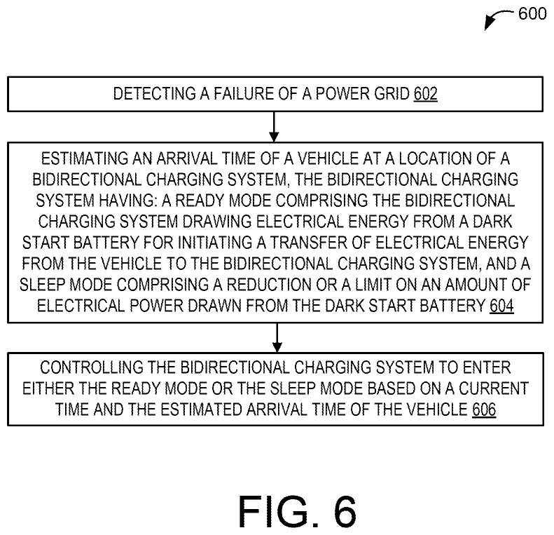

FIG. 6 illustrates an example process 600 for controlling a bidirectional charging system. The process 600 may be implemented as instructions, for example, stored on the controller 310, that when executed by one or more processors perform one or more operations of process 600. The process 600 will be described below with reference to FIG. 3 as an illustrative example. However, one skilled in the art will appreciate that the embodiments disclosed herein are not to be limited to this implementation only.

The process 600 may include detecting a failure of the power grid 302 (602). The failure of the power grid 302 may be a blackout (whether intentional or non-intentional), intermittent or unstable power delivery, or other failures that affect the delivery of electrical energy. In examples, one or more sensors may be used to detect the failure of the power grid 302. The one or more sensors may include current sensors or other sensors for detecting a power grid failure. In examples, the one or more sensors may be in wired or wireless communication with the bidirectional charging system 322 (e.g., with the controller 310).

The process 600 may include estimating an arrival time of the vehicle 320 at a location of the bidirectional charging system 322, the bidirectional charging system 322 having: a ready mode comprising the bidirectional charging system 322 drawing electrical energy from the dark start battery 314 for initiating a transfer of electrical energy from the vehicle 320 to the bidirectional charging system 322, and a sleep mode comprising a reduction or a limit on an amount of electrical power drawn from the dark start battery 314 (604). In examples, estimating the arrival time of the vehicle 320 may be responsive to detecting the failure of the power grid 302. In some examples, estimating the arrival time of the vehicle 320 may be performed prior to detecting the failure of the power grid 302. In examples, the process 600 may further include determining a location of the vehicle 320 based on location information received from the vehicle 320, with estimating the arrival time of the vehicle 320 at the location of the bidirectional charging system 322 being based on the determined location of the vehicle 320. In examples, the determined location of the vehicle 320 may be used to determine a travel distance or time between the vehicle 320 and the bidirectional charging system 322. The bidirectional charging system 322 may, for example, determine the estimated arrival time of the vehicle 320 based on the determined travel distance or time (e.g., by utilizing GPS navigation information, traffic data, a lookup table correlating travel distances with average travel times, etc.).

In some examples, estimating the arrival time of the vehicle 320 at the location of the bidirectional charging system 322 may be based on historical charging data of the vehicle 320. For example, the historical charging data may indicate the average times (e.g., on respective days of a week) the vehicle 320 is plugged into and out of the bidirectional charging system 322.

The process 600 may include controlling the bidirectional charging system 322 to enter either the ready mode or the sleep mode based on a current time and the estimated arrival time of the vehicle 320 (606).

In examples, controlling the bidirectional charging system 322 to enter the sleep mode may comprise stopping or preventing the bidirectional charging system 322 from drawing the electrical energy from the dark start battery 314 for initiating the transfer of electrical energy from the vehicle 320 to the bidirectional charging system 322 thereby reducing or limiting the amount of electrical power drawn from the dark start battery 314. In some examples, the bidirectional charging system 322 may be controlled to enter the ready mode when a difference between the current time and the estimated arrival time of the vehicle 320 is less than or equal to a threshold time interval. In some examples, the bidirectional charging system 322 may be controlled to enter the sleep mode when the difference between the current time and the estimated arrival time of the vehicle 320 is greater than the threshold time interval. As an example, if the threshold time interval is one (1) hour and the estimated arrival time of the vehicle 320 equals the current time (i.e., the vehicle 320 is already located at the bidirectional charging system 322), the bidirectional charging system 322 may be controlled to enter the ready mode.

In examples, controlling the bidirectional charging system 322 to enter the sleep mode may comprise controlling the bidirectional charging system 322 to enter the sleep mode for a time interval, with the time interval being based on the current time and the estimated arrival time of the vehicle 320. As an example, if the estimated arrival time of the vehicle 320 is five (5) hours from a current time, the time interval may be set to five (5) hours (in examples, the time interval may be set to be greater than or less than five (5) hours, such as greater than or less than by a percentage or a fixed number such as ten (10) minutes). In some examples, the process 600 may further include, upon expiration of the time interval, controlling the bidirectional charging system 322 to enter the ready mode. In some examples, the time interval may comprise a first time interval, and the process 600 may further include: upon expiration of the first time interval, estimating an updated arrival time of the vehicle 320 at the location of the bidirectional charging system 322; and controlling the bidirectional charging system 322 to re-enter the sleep mode or remain in the sleep mode for a second time interval, with the second time interval being based on the updated estimated arrival time of the vehicle 320.

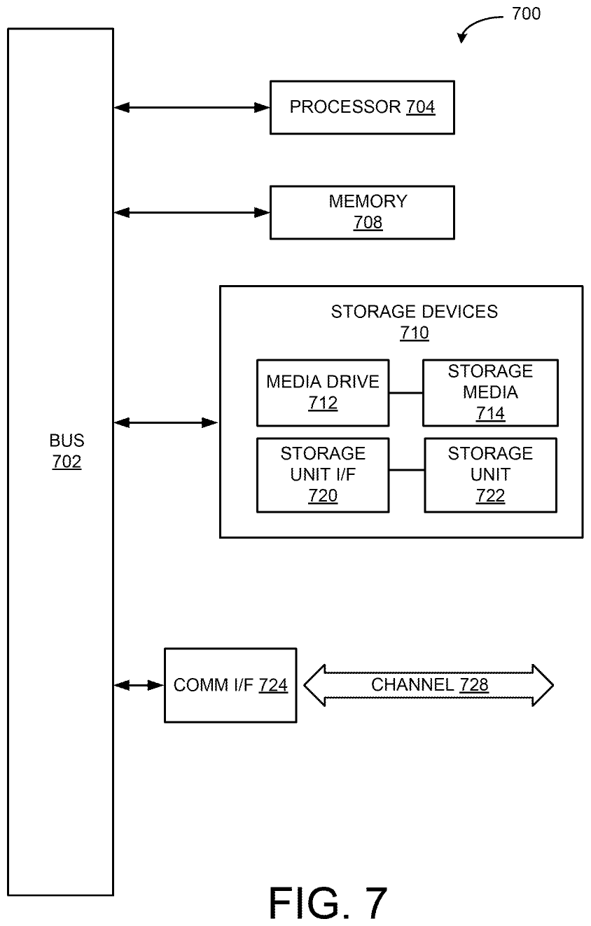

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up the device 324, the vehicle bidirectional charging system 200, and the bidirectional charging system 322. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage devices 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In examples, in addition or alternatively, the information storage devices 710 might include other similar instrumentalities for allowing computer programs or other instructions or data to be loaded into the computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 722, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A bidirectional charging system, comprising:
a dark start battery;
one or more processors; and
memory coupled to the one or more processors to store instructions, which when executed by the one or more processors, cause the one or more processors to perform operations, the operations comprising:
detecting a failure of a power grid, the power grid being electrically connected to the bidirectional charging system; and
responsive to the detection of the failure of the power grid, controlling the bidirectional charging system to enter a sleep mode for a time interval that is less than or equal to a difference between a current time and an estimated arrival time of a vehicle at a location of the bidirectional charging system, the sleep mode comprising a reduction or a limit on an amount of electrical power the bidirectional charging system draws from the dark start battery.

2. The bidirectional charging system of claim 1, wherein the operations further comprise, upon expiration of the time interval, controlling the bidirectional charging system to enter a ready mode, the ready mode comprising the bidirectional charging system drawing electrical energy from the dark start battery for initiating a transfer of electrical energy from the vehicle to the bidirectional charging system.

3. The bidirectional charging system of claim 1, wherein:
the time interval comprises a first time interval; and
the operations further comprise:
upon expiration of the first time interval, estimating an updated arrival time of the vehicle at the location of the bidirectional charging system; and
controlling the bidirectional charging system to either re-enter the sleep mode or remain in the sleep mode for a second time interval, the second time interval being based on the updated estimated arrival time of the vehicle.

4. The bidirectional charging system of claim 1, wherein the operations further comprise:
determining a location of the vehicle based on location information received from the vehicle; and
determining the estimated arrival time of the vehicle at the location of the bidirectional charging system based on the determined location of the vehicle.

5. The bidirectional charging system of claim 1, wherein the operations further comprise determining the estimated arrival time of the vehicle at the location of the bidirectional charging system based on historical charging data of the vehicle.

6. A bidirectional charging system, comprising:
a dark start battery;
one or more processors; and
memory coupled to the one or more processors to store instructions, which when executed by the one or more processors, cause the one or more processors to perform operations, the operations comprising:
estimating an arrival time of a vehicle at a location of the bidirectional charging system, the bidirectional charging system having:
a ready mode comprising the bidirectional charging system drawing electrical energy from the dark start battery for initiating a transfer of electrical energy from the vehicle to the bidirectional charging system, and
a sleep mode comprising a reduction or a limit on an amount of electrical power the bidirectional charging system draws from the dark start battery; and
controlling the bidirectional charging system to enter either the ready mode or the sleep mode based on a current time and the estimated arrival time of the vehicle.

7. The bidirectional charging system of claim 6, wherein controlling the bidirectional charging system to enter either the ready mode or the sleep mode based on the current time and the estimated arrival time of the vehicle comprises:
controlling the bidirectional charging system to enter the ready mode when a difference between the current time and the estimated arrival time of the vehicle is less than or equal to a threshold time interval; and
controlling the bidirectional charging system to enter the sleep mode when the difference between the current time and the estimated arrival time of the vehicle is greater than the threshold time interval.

8. The bidirectional charging system of claim 7, wherein controlling the bidirectional charging system to enter the sleep mode comprises controlling the bidirectional charging system to enter the sleep mode for a time interval, the time interval being less than or equal to the difference between the current time and the estimated arrival time of the vehicle.

9. The bidirectional charging system of claim 8, wherein the operations further comprise, upon expiration of the time interval, controlling the bidirectional charging system to enter the ready mode.

10. The bidirectional charging system of claim 8, wherein:
the time interval comprises a first time interval; and
the operations further comprise:
upon expiration of the first time interval, estimating an updated arrival time of the vehicle at the location of the bidirectional charging system; and
controlling the bidirectional charging system to either re-enter the sleep mode or remain in the sleep mode for a second time interval, the second time interval being based on the updated estimated arrival time of the vehicle.

11. The bidirectional charging system of claim 6, wherein:
the operations further comprise determining a location of the vehicle based on location information received from the vehicle; and
the estimated arrival time of the vehicle at the location of the bidirectional charging system is estimated based on the determined location of the vehicle.

12. The bidirectional charging system of claim 6, wherein the estimated arrival time of the vehicle at the location of the bidirectional charging system is estimated based on historical charging data of the vehicle.

13. The bidirectional charging system of claim 6, further comprising one or more sensors to detect a failure of a power grid; and
wherein:
the bidirectional charging system is electrically connected to the power grid;
the operations further comprise detecting the failure of the power grid using the one or more sensors; and
estimating the arrival time of the vehicle at the location of the bidirectional charging system is responsive to detecting the failure of the power grid.

14. The bidirectional charging system of claim 6, wherein the sleep mode further comprises stopping or preventing the bidirectional charging system from drawing the electrical energy from the dark start battery for initiating the transfer of the electrical energy from the vehicle to the bidirectional charging system.

15. A method for controlling a bidirectional charging system, the method comprising:
estimating, via one or more processors of the bidirectional charging system, an arrival time of a vehicle at a location of the bidirectional charging system, the bidirectional charging system having:
a ready mode comprising the bidirectional charging system drawing electrical energy from a dark start battery of the bidirectional charging system for initiating a transfer of electrical energy from the vehicle to the bidirectional charging system, and
a sleep mode comprising a reduction or a limit on an amount of electrical power the bidirectional charging system draws from the dark start battery; and
controlling, via the one or more processors, the bidirectional charging system to enter either the ready mode or the sleep mode based on a current time and the estimated arrival time of the vehicle.

16. The method of claim 15, wherein controlling the bidirectional charging system to enter either the ready mode or the sleep mode based on the current time and the estimated arrival time of the vehicle comprises:
controlling the bidirectional charging system to enter the ready mode when a difference between the current time and the estimated arrival time of the vehicle is less than or equal to a threshold time interval; and
controlling the bidirectional charging system to enter the sleep mode when the difference between the current time and the estimated arrival time of the vehicle is greater than the threshold time interval.

17. The method of claim 16, wherein controlling the bidirectional charging system to enter the sleep mode comprises controlling the bidirectional charging system to enter the sleep mode for a time interval, the time interval being less than or equal to the difference between the current time and the estimated arrival time of the vehicle.

18. The method of claim 17, wherein:
the time interval comprises a first time interval; and
the method further comprises:
upon expiration of the first time interval, estimating an updated arrival time of the vehicle at the location of the bidirectional charging system; and
controlling the bidirectional charging system to either re-enter the sleep mode or remain in the sleep mode for a second time interval, the second time interval being based on the updated estimated arrival time of the vehicle.

19. The method of claim 15, wherein estimating the arrival time of the vehicle at the location of the bidirectional charging system is based on vehicle location information indicating a location of the vehicle.

20. The method of claim 15, wherein estimating the arrival time of the vehicle at the location of the bidirectional charging system is based on historical charging data of the vehicle.
